(19) United States
(12) Patent Application Publication
(10) Pub. No.: US 2007/0103426 A1
(43) Pub. Date: May 10, 2007

(54) Electrophoretic display unit

(76) Inventors: Mark Thomas Johnson, Eindhoven (NL); Guofu Zhou, Eindhoven (NL); Neculai Ailenei, Heerlen (NL)

Correspondence Address: PHILIPS INTELLECTUAL PROPERTY & STANDARDS, P.O. BOX 3001, BRIARCLIFF MANOR, NY, 10510, US

(21) Appl. No.: 10/559,048

(22) PCT Filed: May 25, 2004
(86) PCT No.: PCT/IB04/50768

§ 371 Date: Dec. 1, 2005

(30) Foreign Application Priority Data
Jun. 4, 2003 (EP) 03101616.5

(51) Int. Cl. G09G 3/34

(52) U.S. Cl. 345/107

(57) ABSTRACT

Electrophoretic display units (1) can get a shorter total image update time by generating and supplying at least some of the data independent signals (Sh₁, Sh₂, S₄, Sh₅) during the processing of image information (Del). The processing is done to calculate the data-dependent signals (R,Dr). Data-independent signals (Sh₁, Sh₂, Sh₃, Sh₄, Sh₅) do not depend on this processing, so these signals may be supplied during the processing. The total image update time is formed by the sum of the time required for image processing (Del) and of the subsequent time required to supply the data-dependent signals (R,Dr) to the pixels (11).

The invention relates to an electrophoretic display unit, to a display device which comprises an electrophoretic display unit, to a method for updating an image to be displayed via an electrophoretic display unit, to a processor program product for updating an image to be displayed via an electrophoretic display unit, and to driving circuitry.

Display devices of this type for example correspond with monitors, laptop computers, personal digital assistants (PDAs), mobile telephones and electronic books, electronic newspapers, electronic magazines etc.

A prior art electrophoretic display unit is known from international patent application WO 99/53373. This patent application discloses an electronic ink display comprising two substrates, with one of the substrates being transparent and having a common electrode (also known as counter electrode) and with the other substrate being provided with pixel electrodes arranged in rows and columns. A crossing between a row and a column electrode is associated with a pixel. The pixel is formed between a part of the common electrode and a pixel electrode. The pixel electrode is coupled to the drain of a transistor, of which the source is coupled to the column electrode and of which the gate is coupled to the row electrode. This arrangement of pixels, transistors and row and column electrodes jointly forms an active matrix. A row driver (select driver) selects a row of pixels and a column driver (data driver) supplies a data signal to the selected row of pixels via the column electrodes and the transistors. The data signal corresponds to data to be displayed.

Furthermore, an electronic ink is provided between the pixel electrode and the common electrode provided on the transparent substrate. The electronic ink comprises multiple microcapsules of about 10 to 50 microns in diameter. Each microcapsule comprises positively charged white particles and negatively charged black particles suspended in a fluid. When a positive field is applied to the pixel electrode, the white particles move to the side of the microcapsule directed to the transparent substrate, and the pixel becomes visible to a viewer. Simultaneously, the black particles move to the pixel electrode on the opposite side of the microcapsule where they are hidden from the viewer. By applying a negative field to the pixel electrode, the black particles move to the common electrode on the side of the microcapsule directed to the transparent substrate, and the pixel appears dark to a viewer. Simultaneously, the white particles move to the pixel electrode on the opposite side of the microcapsule where they are hidden from the viewer. When the electric fields are removed, the display device remains in the acquired state and exhibits a bistable character.

To reduce the dependence of the optical response of the electrophoretic display unit on the history of the pixels, preset signals (comprising data-independent signals) are supplied before the drive signals (comprising data-dependent signals) are supplied. These preset signals comprise pulses representing energies which are sufficient to release the electrophoretic particles from a static state at one of the two electrodes, but which are too low to allow the particles to reach the other one of the electrodes. Because of the reduced dependence, the optical response to identical data will be substantially equal, regardless of the history of the pixels. The underlying mechanism can be explained by the fact that after the display device is switched to a predetermined state, for example a black state, the electrophoretic particles come to a static state. When a subsequent switching to the white state takes place, the momentum of the particles is low because their starting speed is close to zero. This results in great dependence on the previous state and requires a long switching time to overcome this great dependence. The application of the preset signals increases the momentum of the electrophoretic particles and thus reduces the dependence (and allows a shorter switching time).

To update an image displayed via an electrophoretic display unit, the total image update time is formed by the sum of the time required for image processing, the subsequent time required to supply, the data-independent signals row by row, to all pixels in a row simultaneously (by selecting a row via the row driver and supplying the data-independent signals to the pixels via the column driver) and the subsequent time required to supply the data-dependent signals to the pixels in a row row by row (by selecting a row via the row driver and by supplying the data-dependent signals via the column driver to the pixels in that row).

The known electrophoretic display unit is disadvantageous, inter alia, due to the fact that the total image update time is relatively long.

It is an object of the invention, inter alia, to provide an electrophoretic display unit having a relatively short total image update time. The invention is defined by the independent claims. The dependent claims define advantageous embodiments.

The electrophoretic display unit according to the invention comprises pixels, and driving circuitry (20, 30, 40) for receiving image information and for updating an image to be displayed via the pixels (11), the driving circuitry (20, 30, 40) comprising:
means for generating data-independent signals (Sh₁, Sh₂, Sh₃, Sh₄, Sh₅) and supplying the data-independent signals (Sh₁, Sh₂, Sh₃, Sh₄, Sh₅) to the pixels (11),
means for processing (20) image information; and means for generating (20, 30, 40) data-dependent signals (R,Dr) based on processed image information and supplying the data-dependent signals (R,Dr) to the pixels (11) for displaying an updated image,
   at least some of the data-independent signals (Sh₁, Sh₂, Sh₄, Sh₅) being generated and supplied to the pixels (11) before the image information has been processed completely.

By generating and supplying at least some of the data-independent signals to the pixels before the image information has been processed completely, in other words by generating and supplying at least some of the data-independent signals to the pixels already during the processing of the image information, time is saved, and the total image update time is reduced. The fact that it is possible to generate and supply at least some of the data-independent signals to the pixels already during the processing of the image information is based on the recognition that this processing of image information is just done to calculate the data-dependent signals. The data-independent signals do not depend on the data to be displayed and can therefore be generated and supplied earlier. As a result, the total image update time is now, for example, formed by the sum of the time required for image processing and the subsequent time required to supply the data-dependent signals to the pixels. The supply of the data-independent signals to all pixels in a row, row by row, is now carried out at least partly simultaneously with the image processing.

An arrival of (new) image information is detected and an image update command is generated in response. The processing of the image information being ready is detected and an image-processing-ready-command is generated in response. These two simple commands are used to define the starting and end point of a time interval during which the image information is processed. This processing of image information may comprise the loading of the (new) image information, the comparing of present images and new images, the interaction with temperature sensors, the accessing of memories containing look-up tables of drive waveforms etc.

An embodiment of an electrophoretic display unit according to the invention is defined by claim 2. Shaking pulses for example correspond with the preset pulses discussed before. Driving pulses move the particles to the desired optical state. Reset pulses form part of the data-dependent signals in this embodiment. They precede the driving pulses to further improve the optical response of the electrophoretic display unit by defining a flexible starting point for the driving pulses. This starting point may be black or white and is selected in dependence on the closest gray value of the following driving pulses. Alternatively, the reset pulses may form part of the data-independent signals and then precede the driving pulses to further improve the optical response of the electrophoretic display unit, by defining a fixed starting point (fixed black or fixed white) for the driving pulses. In certain embodiments, the reset pulses may be of zero length.

An embodiment of an electrophoretic display unit according to the invention is defined by claim 3. This single shaking (the shaking pulses are generated substantially immediately after an arrival of the image information) can be implemented most easily by using, for example, the image update command for triggering this single shaking. However, a pause between the end of the shaking pulses and the image-processing-ready-command (the start of the reset pulse) may lead to a small deterioration in image quality.

An embodiment of an electrophoretic display unit according to the invention is defined by claim 4. In this embodiment double shaking is applied wherein a first part of the shaking pulses is generated substantially immediately after an arrival of the image information and a second part of the shaking pulses is generated after the reset pulse and before the driving pulse have been generated. Compared to single shaking, this double shaking offers shaking compensation for the pause between the end of the first part of the shaking pulses and the start of the reset pulse, by introducing the second part of the shaking pulses.

An embodiment of an electrophoretic display unit according to the invention is defined by claim 5. This single shaking by which the shaking pulses are generated substantially immediately before the reset pulse can be implemented by using the image update command for example for starting a counter to trigger the single shaking at a predefined counter value. Then, no pause is present any longer between the end of the shaking pulses and the start of the reset pulse.

An embodiment of an electrophoretic display unit according to the invention is defined by claim 6. By generating the shaking pulses substantially during a time-interval during which the image information is processed, again the pause is no longer present.

Further, the shaking during a maximum time interval leads to maximum image quality.

According to this embodiment, two options are open, firstly the generation of a larger number of shaking pulses (compared to the previous embodiments) during the entire time interval, with each pulse for example having the same energy (the same width and the same height or amplitude) as before, and secondly, the generation of the same or a smaller number of shaking pulses (compared to the previous embodiments) during the entire time interval, with each pulse now having more energy than before (by having an increased width).

Embodiments of a display device according to the invention, of a method according to the invention and of a processor program product according to the invention correspond with the embodiments of an electrophoretic display unit according to the invention.

The invention is based on an insight, inter alia, that the processing of image information is just done to calculate the data-dependent signals, and is based on a basic idea, inter alia, that the data-independent signals do not depend on the data to be displayed and can therefore be generated and supplied earlier, during the processing of image information.

The invention solves the problem, inter alia, of providing an electrophoretic display unit having a relatively short image update time, and is advantageous, inter alia, in that, the image quality can be maintained and possibly (dependent on the waveforms used) even increased in a shorter total image update time.

These and other aspects of the invention will be apparent from and elucidated with reference to the embodiments(s) described hereinafter.

In the drawings:

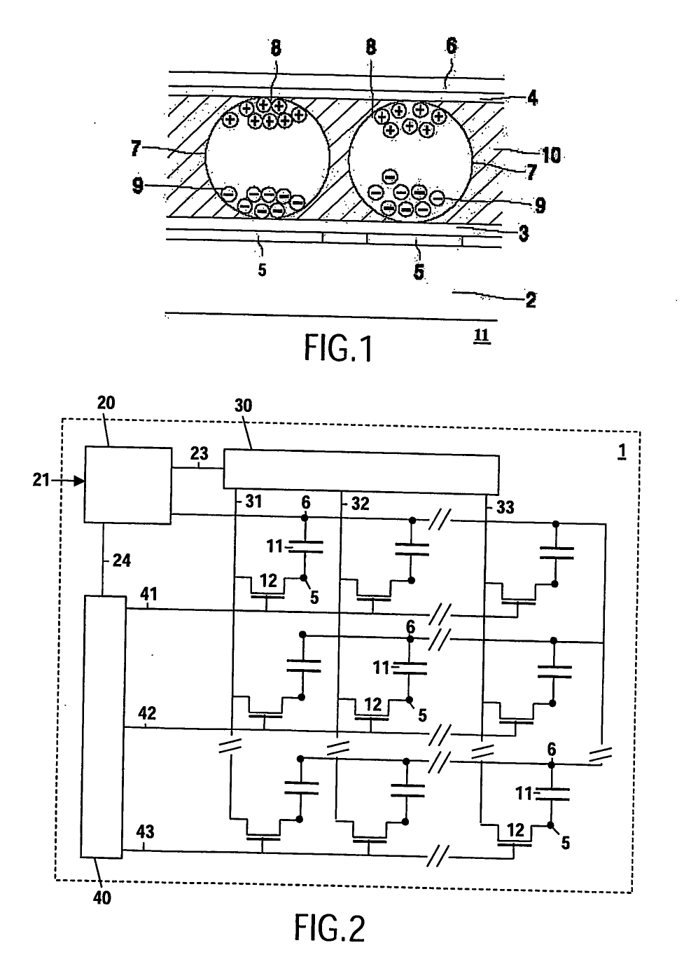

FIG. 1 shows a pixel (in cross-section);

FIG. 2 diagrammatically shows an electrophoretic display unit;

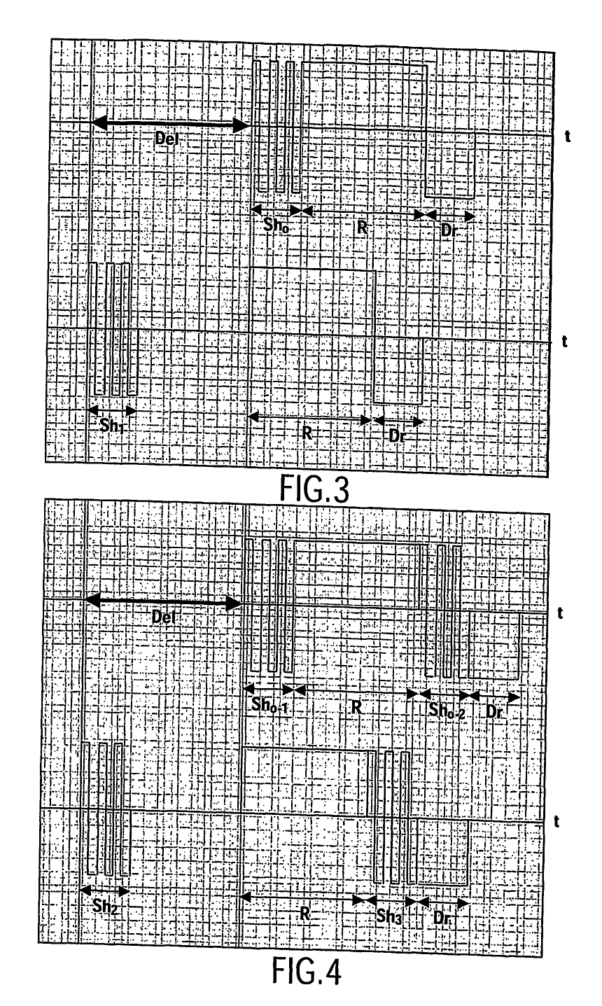

FIG. 3 shows a first prior-art waveform and a first waveform according to the invention;

FIG. 4 shows a second prior-art waveform and a second waveform according to the invention;

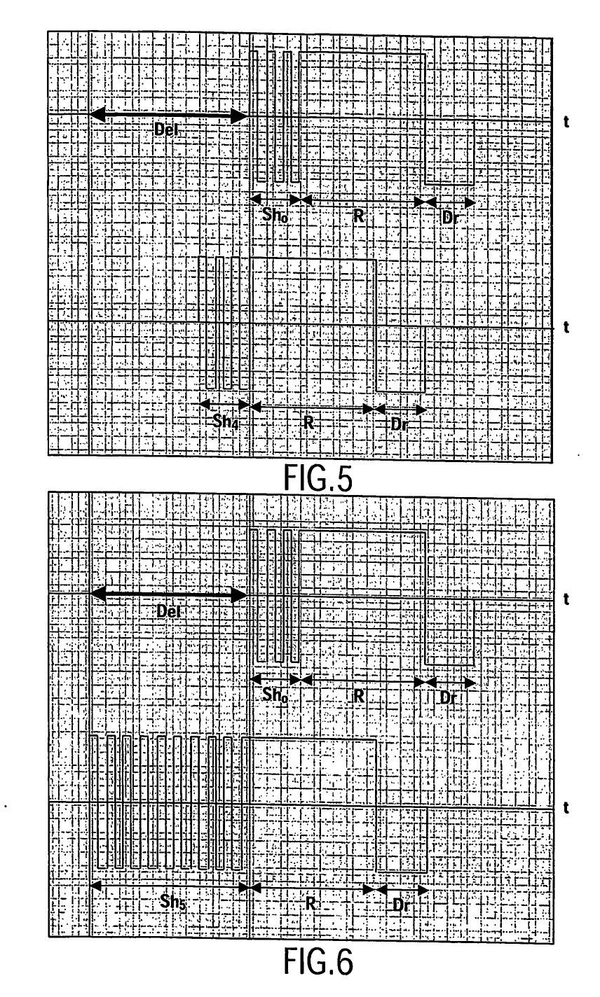

FIG. 5 shows a first prior-art waveform and a third waveform according to the invention; and

FIG. 6 shows a first prior-art waveform and a fourth waveform according to the invention.

The pixel 11 of the electrophoretic display unit shown in FIG. 1 (in cross-section) comprises a base substrate 2, an electrophoretic film (laminated on base substrate 2) with an electronic ink which is present between two transparent substrates 3,4 of, for example, polyethylene. One of the substrates 3 is provided with transparent pixel electrodes 5 and the other substrate 4 is provided with a transparent common electrode 6. The electronic ink comprises multiple microcapsules 7 of about 10 to 50 microns. Each microcapsule 7 comprises positively charged white particles 8 and negatively charged black particles 9 suspended in a fluid 10. When a positive field is applied to the pixel electrode 5, the white particles 8 move to the side of the microcapsule 7 directed to the common electrode 6, and the pixel becomes visible to a viewer. Simultaneously, the black particles 9 move to the opposite side of the microcapsule 7 where they are hidden from the viewer. By applying a negative field to the pixel electrodes 5, the black particles 9 move to the side of the microcapsule 7 directed to the counter electrode 6, and the pixel appears dark to a viewer (not shown). When the electric field is removed, the particles 8,9 remain in the acquired state and the display exhibits a bi-stable character and consumes substantially no power.

The electrophoretic display unit 1 shown in FIG. 2 comprises a matrix of pixels 11 in the area of crossings of row or selection electrodes 41,42,43 and column or data electrodes 31,32,33. These pixels 11 are all coupled to a common electrode 6, and each pixel 11 is coupled to its own pixel electrode 5. The electrophoretic display unit 1 further comprises a row driver 40 (select driver) coupled to the row electrodes 41,42,43 and a column driver 30 (data driver) coupled to the column electrodes 31,32,33 and comprises per pixel 11 an active switching element 12. The electrophoretic display unit 1 is driven by these active switching elements 12 (in this example (thin-film) transistors). The row driver 40 consecutively selects the row electrodes 41,42,43, while the column driver 30 provides a data signal to the column electrodes 31,32,33. Preferably, a controller 20 first processes incoming data arriving via input 21 and generates data signals. Mutual synchronisation between the column driver 30 and the row driver 40 takes place via drive lines 23 and 24. Select signals from the row driver 40 select sequentially the pixel electrodes 5 of respective rows via the transistors 12 of which the drain electrodes are electrically coupled to the pixel electrodes 5 and of which the gate electrodes are electrically coupled to the row electrodes 41,42,43 and of which the source electrodes are electrically coupled to the column electrodes 31,32,33. Data signals present at the column electrode 31,32,33 are transferred to the pixel electrodes 5 of a row of pixels 11 coupled to the drain electrodes of the transistors 12, when that row is selected. Instead of transistors, other switching elements can be used, such as diodes, MIMs, etc. The processor 20, the column driver 30, and the row driver 40 together form the driving circuitry 20,30,40. This driving circuitry may be formed by one or more integrated circuits, which may be combined with other components as an electronic unit.

Incoming data (image information) arriving via input 21 is processed by controller 20. Thereto, controller 20 detects an arrival of the (new) image information and in response generates an image update command, to start the processing of the image information arrived. This processing of image information may comprise the loading of the (new) image information, the comparing of present images (stored in a memory of controller 20) and new images (as defined by the new image information and also to be stored in the memory), the interaction with temperature sensors, the accessing of memories containing look-up tables of drive waveforms etc. Controller 20 then detects this processing of the image information being ready and in response generates an image-processing-ready-command. These two simple commands are therefore used to define the staring and ending point of a time-interval during which the image information is processed.

Then, controller 20 generates the data signals to be supplied to (clocked into) column driver 30 via drive line 23 and generates the selection signals to be supplied to row driver 40 via drive line 24. These data signals comprise data-independent signals (which are the same for all pixels 11) and data-dependent signals (which may or may not vary per pixel 11). The data-independent signals comprise shaking pulses (or preset pulses), with the data-dependent signals comprising a reset pulse and a driving pulse. These shaking pulses comprise pulses representing energies which are sufficient to release the electrophoretic particles 8,9 from a static state at one of the two electrodes 5,6, but which are too low to allow the particles 8,9 to reach the other one of the electrodes 5,6. Because of the reduced dependence, the optical response to identical data will be substantially equal, regardless of the history of the pixels. So, the shaking pulses reduce the dependence of the optical response of the electrophoretic display unit on the history of the pixels. Driving pulses move the particles 8,9 to the desired optical state. Reset pulses form part of the data-dependent signals and precede the driving pulses to further improve the optical response of the electrophoretic display unit, by defining a flexible starting point (black or white, to be selected in dependence on and closest to the gray value to be defined by the following driving pulses) for the driving pulses. Alternatively, the reset pulses may form part of the data-independent signals and then precede the driving pulses to further improve the optical response of the electrophoretic display unit, by defining a fixed starting point (fixed black or fixed white) for the driving pulses. In certain embodiments, the reset pulses are of zero length.

For supplying data-dependent or data-independent signals to the pixels 11, column driver 30 is controlled by controller 20 so that all pixels 11 in a row receive the date-dependent or data-independent signals simultaneously. This is done row by row, with controller 20 controlling row driver 40 in such a way that the rows are selected one after the other (all transistors 12 in the selected row are brought into a conducting state).

To update an image displayed via the electrophoretic display unit 1, the total image update time is formed by the sum of the time required for image processing and the subsequent time required to supply the data-independent signals and the data-dependent signals to the pixels 11. This prior art total image update time is relatively long.

According to the invention, by generating and supplying at least some of the data-independent signals to the pixels 11 before the image information has been processed completely, in other words by generating and supplying at least some of the data-independent signals to the pixels 11 already during the processing of the image information, time is saved and the total image update time is reduced. The fact that it is possible to generate and supply at least some of the data-independent signals to the pixels 11 already during the processing of the image information is based on the recognition that this processing of image information is just done to calculate the data-dependent signals. The data-independent signals do not depend on the data to be displayed and can therefore be generated and supplied earlier.

FIG. 3 shows a first prior art waveform (upper graph) and a first waveform according to the invention (lower graph). In the upper graph, Del corresponds with a time interval necessary for the processing of image information, Shₒ corresponds with prior art shaking pulses, R corresponds with a reset pulse, and Dr corresponds with a driving pulse. The time interval Del is started by a detection of an arrival of image information and in response generating an image update command, and is finished by a detection of the image information being processed completely and in response generating an image processing ready command, with the time interval Del being situated between the two commands. In the lower graph, Sh₁ corresponds with shaking pulses according to the invention which are supplied during the time interval Del, R corresponds with a reset pulse, and Dr corresponds with a driving pulse. Clearly, the total image update time has been reduced, by supplying the shaking pulses Sh₁ substantially immediately after the arrival of the image information during a first part of the time interval Del and before the processing of image information has been completed. This kind of shaking is called single shaking and can be implement most easily due to the image-update-command being used for triggering this single shaking. A pause between the end of the shaking pulses Sh₁ and the image-processing-ready-command (the start of the reset pulse) may, however, lead to a small deterioration in image quality.

FIG. 4 shows a second prior art waveform (upper graph) and a second waveform according to the invention (lower graph). In the upper graph, Del corresponds with a time interval necessary for the processing of image information, Shₒ₋₁ corresponds with first prior-art shaking pulses, R corresponds with a reset pulse, Shₒ₋₂ corresponds with second prior-art shaking pulses, and Dr corresponds with a driving pulse. In the lower graph, Sh₂ corresponds with first shaking pulses according to the invention which are supplied during the time interval Del, R corresponds with a reset pulse, Sh₃ corresponds with second shaking pulses, and Dr corresponds with a driving pulse. Clearly, the total image update time has been reduced by supplying at least some of the shaking pulses Sh₂ during a first part of the time interval Del substantially immediately after the arrival of the image information, while the remainder of the shaking pulses Sh₃ is supplied between the reset pulse R and the drive pulse Dr. This kind of shaking, as shown in FIG. 4, is called double shaking and offers, compared to the single shaking shown in FIG. 3, shaking compensation for the pause between the end of the shaking pulses Sh₁ and the start of the reset pulse R as shown in FIG. 3 (in other words the end of the first shaking pulses Sh₂ and the start of the reset pulse R as shown in FIG. 4), by introducing the second shaking pulses Sh3.

FIG. 5 shows a first prior-art waveform (upper graph) and a third waveform according to the invention (lower graph). In the upper graph, Del corresponds with a time interval necessary for the processing of image information, Shₒ corresponds with prior-art shaking pulses, R corresponds with a reset pulse, and Dr corresponds with a driving pulse. In the lower graph, Sh₄ corresponds with shaking pulses according to the invention which are supplied during the time interval Del, R corresponds with a reset pulse, and Dr corresponds with a driving pulse. Clearly, the total image update time has been reduced by supplying the shaking pulses Sh₄ substantially immediately before the reset pulse R and during a second part of the time interval Del before the processing of image information has been completed. This kind of single shaking can be implemented by using the image-update-command for example for starting a counter to trigger the shaldng at a predefined counter value. Then, there is no longer any pause between the end of the shaking pulses S₄ and the start of the reset pulse R.

FIG. 6 shows a first prior-art waveform (upper graph) and a fourth waveform according to the invention (lower graph). In the upper graph, Del corresponds with a time interval necessary for the processing of image information, Shₒ corresponds with prior-art shaking pulses, R corresponds with a reset pulse, and Dr corresponds with a driving pulse. In the lower graph, Sh₅ corresponds with shaking pulses according to the invention which are supplied during the entire time interval Del, R corresponds with a reset pulse, and Dr corresponds with a driving pulse. Clearly, the total image update time has been reduced, by supplying the shaking pulses substantially during the time interval Del during which the image information is processed. By generating and supplying the shaking pulses Sh₅ during the entire time interval Del, again the pause mentioned before, is no longer there. Further, the shaking during a maximum time interval Del leads to maximum image quality. According to this, two options are open, firstly the generation of a larger number of shaking pulses (compared to FIGS. 3, 4, 5) during the entire time interval Del, with each pulse for example having the same energy (the same width and the same height or amplitude) as before, and secondly the generation of the same or a smaller number of shaking pulses (compared to FIGS. 3,4,5) during the entire time interval Del, with each pulse now having more energy than before (by having an increased width).

In the embodiments in accordance with this invention which are presented here, the data-independent (shaking) signals during the time interval Del, in accordance with this invention, have been given the same amplitude as the remaining data-dependent signals. While this may be necessary in display devices with simple driving electronics, in other embodiments, the amplitudes of the data-independent signals may differ from those of the data-dependent signals.

Moreover, if the reset pulse R is selected to be a data-independent signal, the reset pulse R may be provided, together with the shaking pulses during the time interval Del.

The display device as claimed in claim 5 may be an electronic book. The medium for storing information may be a memory stick, integrated circuit, a memory or other storage device for storing for example, the content of a book to be displayed on the display unit.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention is based on an insight, inter alia, that the processing of image information is just done to calculate the data-dependent signals, and is based on a basic idea, inter alia, that the data-independent signals do not depend on the data to be displayed and can therefore be generated and supplied earlier, during the processing of image information.

The invention solves the problem, inter alia, by providing an electrophoretic display unit having a relatively short image update time, and is advantageous, inter alia, in that, at a shorter total image update time, the image quality can be maintained and possibly even increased (depending on the waveforms used).

1. An electrophoretic display unit (1) comprising pixels (11), and driving circuitry (20, 30, 40) for receiving image information and for updating an image to be displayed via the pixels (1), the driving circuitry (20, 30, 40) comprising:
means for generating data-independent signals (Sh₁, Sh₂, Sh₃, Sh₄, Sh₅) and supplying the data-independent signals (Sh₁, Sh₂, Sh₃, Sh₄, Sh₅) to the pixels (11),
means for processing (20) image information; and means for generating (20, 30, 40) data-dependent signals (R,Dr) based on processed image information and supplying the data-dependent signals (R,Dr) to the pixels (11) for displaying an updated image, at least some of the data-independent signals (Sh₁, Sh₂, Sh₄, Sh₅) being generated and supplied to the pixels (11) before the image information has been processed completely.

2. An electrophoretic display unit (1) according to claim 1, wherein the data-independent signals comprise shaking pulses (Sh₁, Sh₂, Sh₃, Sh₄, Sh₅), and the data-dependent signals comprise a reset pulse (R) and a driving pulse (Dr).

3. An electrophoretic display unit (1) according to claim 2, wherein the shaking pulses (Sh₁) are generated substantially immediately after an arrival of the image information.

4. An electrophoretic display unit (1) according to claim 2, wherein a first part of the shaking pulses (Sh₂) is generated substantially immediately after an arrival of the image information, and a second part of the shaking pulses (Sh₃) is generated after the reset pulse (R) and before the driving pulse (Dr) have been generated.

5. An electrophoretic display unit (1) according to claim 2, wherein the shaking pulses (Sh₄) are generated substantially immediately before the reset pulse (R).

6. An electrophoretic display unit (1) according to claim 2, wherein the shaking pulses (Sh₅) are generated substantially during a time interval (Del) during which the image information is processed.

7. A display device which comprises a electrophoretic display unit (1) according to claim 1, and a storage medium for storing images to be displayed.

8. A method for updating an image to be displayed via an electrophoretic display unit (1) comprising pixels (11), whereby image information is processed for the updating, the method comprising the steps of:
generating data-independent signals (Sh₁, Sh₂, Sh₃, Sh₄, Sh₅) and supplying the data-independent signals (Sh₁, Sh₂, Sh₃, Sh₄, Sh₅) to the pixels (11); and
in response to the processing of the image information, generating data-dependent signals (R,Dr) and supplying the data-dependent signals (R,Dr) to the pixels (11) for displaying an updated image,
at least some of the data-independent signals (Sh₁, Sh₂, Sh₄, Sh₅) being generated and supplied to the pixels (11) before the image information has been processed completely.

9. A processor program product for updating an image to be displayed via an electrophoretic display unit (1) comprising pixels (11), in which image information is processed for the updating, the processor program product comprising the functions of:
generating data-independent signals (Sh₁, Sh₂, Sh₃, Sh₄, Sh₅) and supplying the data-independent signals (Sh₁, Sh₂, Sh₃, Sh₄, Sh₅) to the pixels (11); and
in response to the processing of the image information, generating data-dependent signals (R,Dr) and supplying the data-dependent signals (R,Dr) to the pixels (11) for displaying an updated image,
at least some of the data-independent signals (Sh₁, Sh₂, Sh₄, Sh₅) being generated and supplied to the pixels (11) before the image information has been processed completely.

10. Driving circuitry (20, 30, 40) for receiving image information and for updating an image to be displayed via pixels (11) of an electrophoretic display unit (1), the driving circuitry (20, 30, 40) comprising:
means for generating data-independent signals (Sh₁, Sh₂, Sh₃, Sh₄, Sh₅) and supplying the data-independent signals (Sh₁, Sh₂, Sh₃, Sh₄, Sh₅) to the pixels (11),
means for processing (20) image information; and means for generating (20, 30, 40) data-dependent signals (R,Dr) based on processed image information and supplying the data-dependent signals (R,Dr) to the pixels (11) for displaying an updated image,
at least some of the data-independent signals (Sh₁, Sh₂, Sh₄, Sh₅) being generated and supplied to the pixels (11) before the image information has been processed completely.
